(19) United States
(12) Patent Application Publication
(10) Pub. No.: US 2024/0247534 A1
(43) Pub. Date: Jul. 25, 2024

(54) DEVICE FOR MONITORING A DOORWAY OF A VEHICLE, AND VEHICLE

(71) Applicant: BODE - DIE TÜR GMBH, Kassel (DE)

(72) Inventors: Torben KUNZEMANN, Naumburg (DE); Diako RASEKHI COOCHESFAHANI, Kassel (DE); Guido BACHMANN, Guxhagen (DE)

(21) Appl. No.: 18/564,339

(22) PCT Filed: May 27, 2022
(86) PCT No.: PCT/EP2022/064448

§ 371 Date: Nov. 27, 2023

(30) Foreign Application Priority Data
May 27, 2021 (DE) 20 2021 102 909.9

(51) Int. Cl. E05F 15/73

(52) U.S. Cl. CPC E05F 15/73; E05F 2015/765; E05F 2015/767; E05Y 2900/50

(57) ABSTRACT

A device for monitoring a doorway of a vehicle, in particular of a rail vehicle, wherein the doorway can be closed with a single-leaf or double-leaf door system, includes at least one monitoring sensor, which is designed to monitor a monitoring area enclosing the doorway, adjacent to it or spaced apart from it.

The at least one monitoring device is arranged in the area of a door drive associated with the respective door system.

### CROSS-REFERENCE TO RELATED APPLICATIONS

This application is a 35 U.S.C. § 371 National Stage patent application of PCT/EP2022/064448, filed on 27 May 2022, which claims the benefit of German patent application 20 2021 102 909.9, filed on 27 May 2021, the disclosures of which are incorporated herein by reference in their entirety.

### TECHNICAL FIELD

The present disclosure relates to a device for monitoring a doorway of a vehicle, in particular of a rail vehicle, wherein the doorway can be closed with a single-leaf or double-leaf door system, comprising at least one monitoring sensor, which is designed to monitor a monitoring area enclosing the doorway, adjacent to it or spaced apart from it. The present disclosure also relates to a vehicle, which has such a device.

According to the disclosure, a vehicle can, for example, be a public transport vehicle. In particular, the vehicle can be a rail vehicle, e.g. a train, a light rail vehicle, a tram, an underground, etc. Such a vehicle can also be a wheeled vehicle such as a bus. The disclosure relates to the boarding area (which allows people to get on and off the vehicle) of the vehicle, which is referred to herein as the doorway area. A doorway area should be understood as an opening of the vehicle wall, which can be closed with a door system. This can be designed to be single-leaf or double-leaf in the present disclosure, i.e. closable with one or two door leaves. The single-leaf or double-leaf door system can be a sliding door system, a swing door system or a sliding plug door system.

### BACKGROUND

The use of suitable sensors for monitoring vehicle doorways (i.e. the boarding areas of public transport vehicles) is known in principle. When boarding and alighting such a vehicle, not only do a plurality of people pass each other, but unwanted objects, some of them dangerous, may also be present in said boarding area. Said sensors can therefore be used in particular for monitoring the orderly boarding and alighting of passengers (congestion in the boarding area can be identified, for example), for solving criminal offences (e.g. theft) or for preventing dangerous situations (identifying tripping hazards, unwanted objects, etc.).

Known sensors are currently frequently arranged directly on the respective door leaves or in the area of the vehicle exterior panel (e.g. above the doorway). This is disadvantageous because the cables/lines required for the electrical supply or signal transmission are designed in the form of drag chains in the case of the arrangement of a sensor on a door leaf (these are carried along with the door leaves), or in the case of the arrangement of a sensor on the outside of the vehicle are led through additional holes in the vehicle panelling. This creates additional construction work and can also constitute a mechanical vulnerability. Furthermore, drag chains or holes in the vehicle panelling (if not adequately sealed) may be subject to undesirable weathering effects and reduce service life.

### SUMMARY

The present disclosure is therefore provides a device for monitoring a doorway of a vehicle that overcomes the shortcomings described.

This is achieved by providing a device and a vehicle according to the claims.

The device according to the disclosure is designed for monitoring a doorway of a vehicle, in particular of a rail vehicle. The doorway can be closed with a single-leaf or double-leaf door system. The device comprises at least one monitoring sensor, which is designed to monitor a monitoring area enclosing the doorway, adjacent to it or spaced apart from it and is characterized in that the at least one monitoring sensor is arranged in the area of a door drive associated with the respective door system.

As mentioned, the monitoring area can enclose the area of the doorway (i.e. a door threshold area). The monitoring area can also be adjacent to the area of the doorway (e.g. towards the inside or outside of the vehicle) or spaced apart from it. The monitoring area is determined by the type of sensor, its range, the field-of-view that can be generated, sensor parameters and the positioning/alignment of the sensor. The monitoring area can be determined by one or more sensors. In the case of several monitoring areas, these can overlap in a defined manner, adjoin each other or be spaced apart. The totality of such monitoring areas can be understood as the “monitoring area” within the meaning of the disclosure. Depending on the type of sensor, certain observable features (to be monitored) in the monitoring area can be monitored. Stationary and/or moving information can be monitored, such as the number of people in the monitoring area, the stationary arrangement of objects (e.g. pieces of luggage) or movements of people/objects. Data detected or recorded by the at least one sensor in the monitoring area can be evaluated directly (manually or automatically) with regard to predefinable criteria. Automated/manual evaluation can be computer-assisted, i.e. using a computer or a computing unit. The computer/computing unit can be a direct part of the monitoring sensor, or be connected to the monitoring sensor by signalling. The computer/computing unit can be arranged on-board the vehicle or externally to it. The computer/computing unit can perform the evaluation using a software, a routine, an algorithm (also on the basis of artificial intelligence). Furthermore, the detected or recorded data can be stored temporarily or for a longer duration in a storage unit. Data can be transferred wirelessly or by cable to a computer/computing unit (e.g. a server, controller or the like) provided in the vehicle (on-board) or externally to it.

As mentioned, the at least one monitoring sensor is arranged in the area of a door drive associated with the respective door system. This avoids the complex wiring known from the prior art (e.g. when arranging a monitoring sensor on a door leaf). There is also no need to provide a trailing cable to ensure power supply or data exchange when the door leaves are moved. Furthermore, electrical supply sources and data lines already provided in the area of the door drive can be connected directly to the monitoring sensor and used. The monitoring sensor can thus be arranged in a fixed position. For example, the monitoring sensor can be mounted in or attached to a housing of the door drive. It can be attached mechanically, in particular releasable attachment is possible, to make it easier to replace the sensor for maintenance or in the case of damage. The monitoring sensor can also be arranged in a recess of a housing of the door drive. The monitoring sensor can also be retrofitted to existing systems.

Further advantageous embodiments of the disclosure are disclosed in the subclaims and in the following description of the features set out in the subclaims.

According to a first embodiment of the disclosure, it can be provided that the at least one monitoring sensor is arranged directly on the door drive. A “direct” arrangement can mean that the at least one monitoring sensor can be arranged on a mechanical component associated with the door drive or its housing. It can be attached releasably or non-detachably. A releasable attachment can use a screw connection, which can be provided, for example, between a sensor housing accommodating the monitoring sensor and a component (or a housing) of the door drive. Other means of attachment can also be considered. A non-detachable connection can be understood, for example, as a welded connection or an adhesive connection.

According to a further embodiment of the disclosure, it can be provided that the single-leaf door system has a door leaf, and that the at least one monitoring sensor is arranged in the area of a closing edge between the door leaf and the doorway. As described, the at least one monitoring sensor is arranged on a door drive, i.e. the door drive, or a component of same, is arranged in the area of the closing edge between the door leaf and the doorway in such an embodiment.

According to a further embodiment of the disclosure, it can be provided that the double-leaf door system has two door leaves, and the at least one monitoring sensor is arranged in the area of a closing edge between the door leaves. In this case, the closing edge is the main closing edge. As described, the at least one monitoring sensor is arranged on a door drive, i.e. the door drive, or a component of same, is arranged in the area of the main closing edge in such an embodiment.

According to a further embodiment of the disclosure, it can be provided that, in the case of a single-leaf door system, the at least one monitoring sensor is arranged in a retractable manner with respect to the door leaf and a vehicle exterior panel adjoining the doorway. This prevents the monitoring sensor from protruding outside the vehicle. On the one hand, this is advantageous for aerodynamic reasons and also reduces the loading gauge of the vehicle; on the other hand, the retractable arrangement of the monitoring sensor reduces the likelihood of damage, in particular caused by vandalism, to the at least one monitoring sensor. Furthermore, a retracted arrangement of the monitoring sensor is also preferable for aesthetic reasons.

According to a further embodiment of the disclosure, it can be provided that, in the case of a double-leaf door system, the at least one monitoring sensor is arranged in a retractable manner with respect to the door leaves and possibly a vehicle exterior panel adjoining the doorway. An embodiment like this also prevents the monitoring sensor from protruding outside the vehicle. As mentioned, on the one hand, this is advantageous for aerodynamic reasons and reduces the loading gauge of the vehicle; on the other hand, the likelihood of damage, in particular caused by vandalism, to the at least one monitoring sensor is reduced. Furthermore, a retracted arrangement of the monitoring sensor is also preferable for aesthetic reasons.

According to a further embodiment of the disclosure, it can be provided that the size and orientation of the monitoring area can be flexibly adapted. This can be done, for example, by parametric adjustment of operating or measurement parameters, but also by mechanical adjustment of a monitoring lens. Mechanical alignment (e.g. by swivelling the sensor) can also ensure an adjustment of the size and orientation of the monitoring area. Mechanical orientation can be electromechanical, but manual adjustment is also possible.

According to a further embodiment of the disclosure, it can be provided that a plurality of monitoring sensors of the same or different types are provided. The use of monitoring sensors of different types may enable different characteristics or parameters to be monitored (e.g. moving images and certain stationary distinguishing features).

According to a further embodiment of the disclosure, it can be provided that the at least one monitoring sensor is an optical sensor or an electromagnetic radiation-based sensor. In particular, the optical sensor can be a camera, or the electromagnetic radiation-based sensor can be a radar sensor, an ultrasonic sensor, a microwave sensor, a lidar sensor, a laser scanner-based sensor or an infrared sensor. Other sensors known from the prior art can also be used for this purpose. The sensor can, regardless of its type, be designed as a 3D sensor and monitor a three-dimensional space as the monitoring area. The sensor can, regardless of its type, be used to produce static images and/or moving images that can capture dynamic processes over a period of time. In the case of a camera as a sensor, a static image can be a photograph and a moving image can be a video.

As mentioned, an advantage of the disclosure is also achieved by providing a vehicle, in particular a rail vehicle, which comprises a doorway, which can be closed with a single-leaf or double-leaf door system, wherein the single-leaf door system has one door leaf and the double-leaf door system has two door leaves. The vehicle is characterized by a device designed according to the disclosure for monitoring a doorway.

### BRIEF DESCRIPTION OF THE DRAWINGS

The disclosure is explained below in more detail based on drawings. In the drawings:

FIG. 1 shows a perspective view of a section of a vehicle in which the device according to the disclosure is used,

FIG. 2 shows a side view of a doorway, which has a double-leaf door system, and in which the door leaves are in a closed state, comprising the device according to the disclosure, and

FIG. 3 shows a side view of a doorway, which has a double-leaf door system, and in which the door leaves are in an open state, comprising the device according to the disclosure.

### DETAILED DESCRIPTION OF THE DRAWINGS

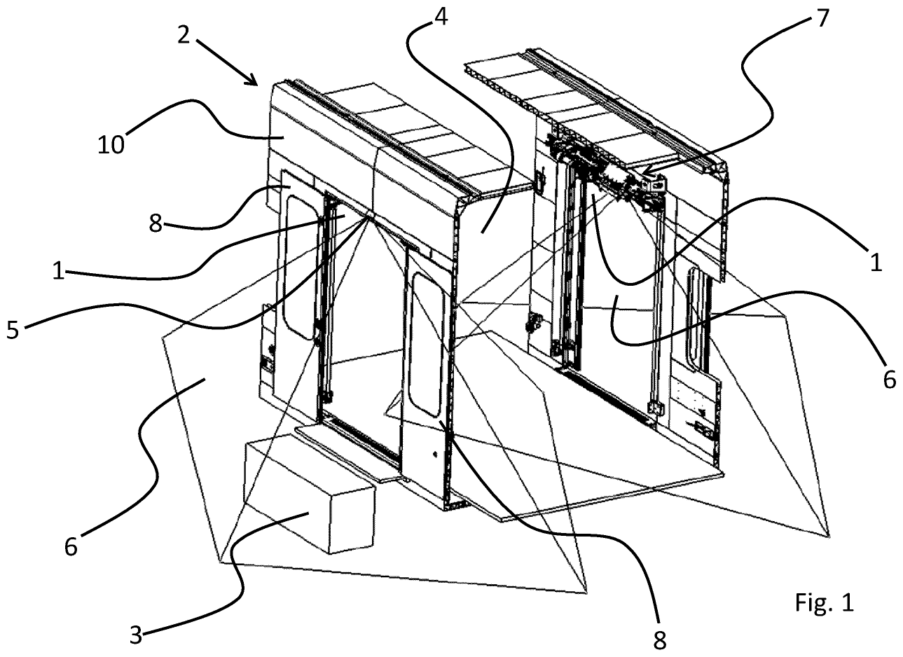

FIG. 1 shows a section of a vehicle 2, in this case of a rail vehicle, in a perspective view. The aforementioned section of the rail vehicle is shown in relation to a section of a platform 3 via which passengers can board the vehicle 2. In the same way, it is possible for passengers to alight from a vehicle interior 4 in the direction of the platform 3. Two opposite doorways 1 of the vehicle 2 are shown here, which enable passengers to board the vehicle/alight the vehicle 2 from the left/right or to the left/right.

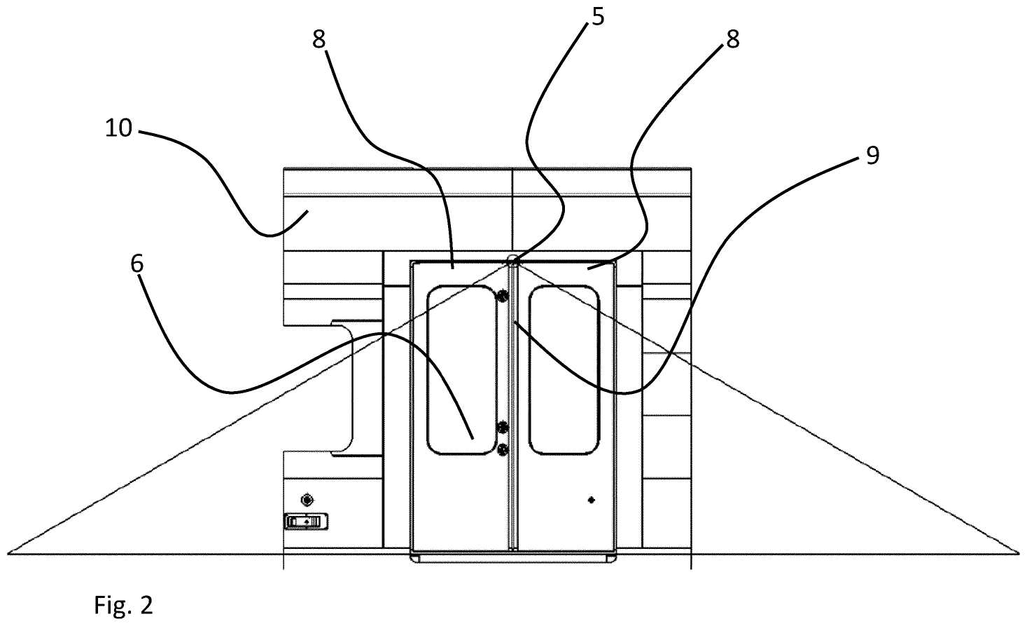

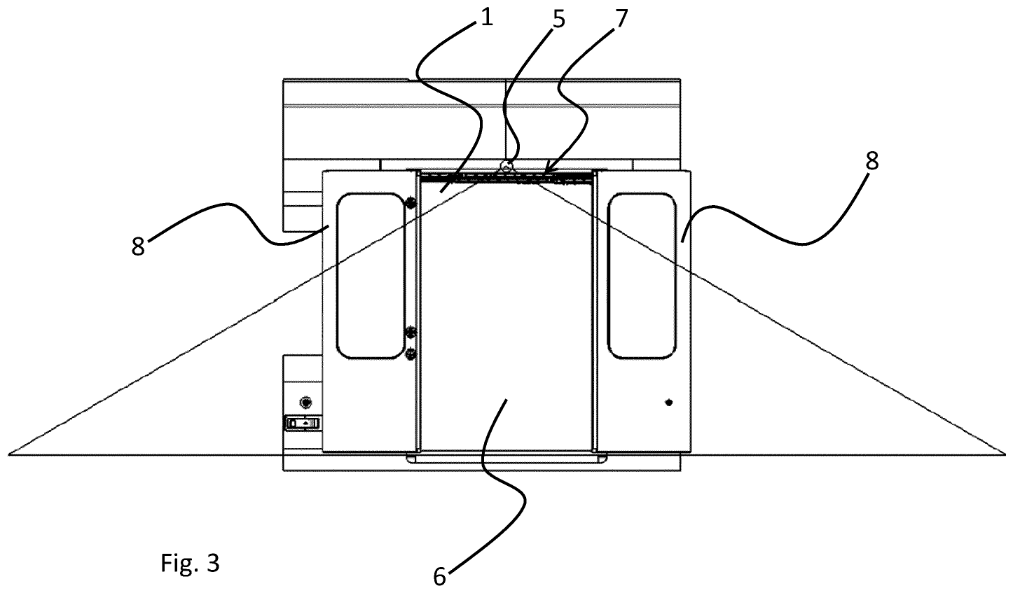

Furthermore, the device proposed in the disclosure for monitoring a doorway 1 of a vehicle 2 is shown. In the examples shown in accordance with FIGS. 1 to 3, the doorway 1 can be closed with a double-leaf door system, which respectively has two door leaves 8. FIG. 2 shows the double-leaf door system in a position with closed door leaves 8, whereas FIG. 3 shows the double-leaf door system in a position with open door leaves 8.

The device comprises at least one monitoring sensor 5, which is designed to monitor a monitoring area 6 enclosing the doorway 1, adjacent to it or spaced apart from it. The at least one monitoring sensor 5 is arranged in the area of a door drive 7 associated with the respective door system. The door drive 7 is arranged above the doorway 1. FIG. 1 shows that the monitoring area 6 can extend both in an area outside the vehicle (e.g. in the area of the platform 3) and in the vehicle interior 4.

FIG. 2 shows that at least one monitoring sensor 5 is arranged in the area of a closing edge 9 between the door leaves 8. Furthermore, the at least one monitoring sensor 5 is arranged in a retractable manner with respect to the door leaves 8 and the vehicle exterior panel 10 adjoining the doorway 1.

1. A device for monitoring a doorway of a vehicle, wherein the doorway is closed with a single-leaf or double-leaf door system, comprising at least one monitoring sensor, which is designed to monitor a monitoring area enclosing the doorway, adjacent to the doorway or spaced apart from the doorway, wherein the at least one monitoring sensor is arranged in the area of a door drive associated with the respective door system.

2. The device according to claim 1, wherein the at least one monitoring sensor is arranged directly on the door drive.

3. The device according to claim 1, wherein the single-leaf door system has a door leaf, and in that the at least one monitoring sensor is arranged in the area of a closing edge between the door leaf and the doorway.

4. The device according to claim 1, wherein the double-leaf door system has two door leaves, and the at least one monitoring sensor is arranged in the area of a closing edge between the door leaves.

5. The device according to claim 3, wherein, in the case of a single-leaf door system, the at least one monitoring sensor is arranged in a retractable manner with respect to the door leaf and a vehicle exterior panel adjoining the doorway.

6. The device according to claim 4, wherein, in the case of a double-leaf door system, the at least one monitoring sensor is arranged in a retractable manner with respect to the door leaves and possibly a vehicle exterior panel adjoining the doorway.

7. The device according to claim 1, wherein the size and orientation of the monitoring area are flexibly adapted.

8. The device according to claim 1, wherein a plurality of monitoring sensors of the same or different types are provided.

9. The device according to claim 1, wherein the at least one monitoring sensor is an optical sensor or an electromagnetic radiation-based sensor.

10. The device according to claim 9, wherein the optical sensor is a camera, or in that the electromagnetic radiation-based sensor is a radar sensor, an ultrasonic sensor, a microwave sensor, a lidar sensor, a laser scanner-based sensor or an infrared sensor.

11. A vehicle comprising: a doorway which is closed with a single-leaf or double-leaf door system, wherein the single-leaf door system has one door leaf and the double-leaf door system has two door leaves, further including a device for monitoring the doorway designed according to claim 1.
